(19) United States
(12) Patent Application Publication
(10) Pub. No.: US 2002/0159586 A1
(43) Pub. Date: Oct. 31, 2002

(54) Panel protective structure of a mobile telephone

(76) Inventor: Tsan-Wen Chiou, Chung Ho City (TW)

Correspondence Address: RABIN & CHAMPAGNE, PC, 1101 14TH STREET, NW, SUITE 500, WASHINGTON, DC, 20005, US

(21) Appl. No.: 09/842,046

(22) Filed: Apr. 26, 2001

(51) Int. Cl. H04M 1/00; H04M 9/00

(52) U.S. Cl. 379/433.11; 379/451

(57) ABSTRACT

A panel protective structure of a mobile telephone is provided, wherein the panel of the mobile telephone is provided with a protective structure that has a vibration absorbing function, for protecting the mobile telephone and the mirror of the liquid crystal display, thereby preventing the mobile telephone from being worn, and thereby preventing the liquid crystal display from being broken when the mobile telephone falls unintentionally.

### BACKGROUND OF THE INVENTION

1. Field of the Invention

The present invention relates to a panel protective structure of a mobile telephone (or cellular phone), and more particularly to a protective plate made of elastic material having a vibration absorbing effect for protecting the mobile telephone.

2. Description of the Related Art

A conventional display plate of a mobile telephone is disclosed in the Taiwanese design Patent Publication No. 410127, entitled by “Display Plate of a Mobile Telephone”, wherein the main body is made of plastic material and is provided with hearing holes, a window, and a transparent mirror mounted in the window. However, the display does not have the vibration absorbing function, so that when the mobile telephone falls, the liquid crystal display is easily broken, the window mirror is easily worn, and the mobile telephone is easily worn.

Another conventional display plate of a mobile telephone is disclosed in the Taiwanese utility model Patent Publication No. 378803, entitled by “Mirror Protective Film Plate of a Display of a Mobile Telephone”, wherein the conventional display mirror of the mobile telephone is provided with a protective film plate with transparent thin film. The transparent thin film is treated by a laser process, so that it may present a spatial laser pattern at a specific inclined angle, so that the protective film plate may present a spatial laser pattern at the specific inclined angle. However, the protective film plate does not have the vibration absorbing function, so that when the mobile telephone falls unintentionally, the liquid crystal display is easily broken, the window mirror is easily worn, and the mobile telephone is easily worn.

### SUMMARY OF THE INVENTION

In accordance with the present invention, there is provided a panel protective structure of a mobile telephone, wherein the panel of the mobile telephone is provided with a protective structure that has a vibration absorbing function, for protecting the mobile telephone and the mirror of the liquid crystal display, thereby preventing the mobile telephone from being worn, and thereby preventing the liquid crystal display from being broken when the mobile telephone falls unintentionally.

The primary objective of the present invention is to provide a panel protective structure of a mobile telephone, wherein the panel is provided with a protective plate that is made of elastic material and has a vibration absorbing function for protecting the mobile telephone.

Another objective of the present invention is to provide a panel protective structure of a mobile telephone, mounted on the periphery of the display, for absorbing the external impact on the display, thereby protecting the display.

A further objective of the present invention is to provide a panel protective structure of a mobile telephone, wherein the panel is provided with a protective plate that is provided with patterns for decorating the appearance of the mobile telephone, thereby improving the appearance of the mobile telephone, and thereby enhancing the viewing effect of the mobile telephone.

In accordance with the panel protective structure of a mobile telephone, a protective plate made of elastic material is fixed on the panel of the mobile telephone, and includes a window mating with the display of the mobile telephone. In addition, the front side of the protective plate is provided with patterns mating with that of the display.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a panel protective structure of a mobile telephone in accordance with the present invention;

FIG. 2 is a side plan cross-sectional assembly view of the panel protective structure of a mobile telephone as shown in FIG. 1; and

FIG. 3 is a perspective assembly view of the panel protective structure of a mobile telephone as shown in FIG. 1.

### DETAILED DESCRIPTION OF THE PREFERRED EMBODIMENTS

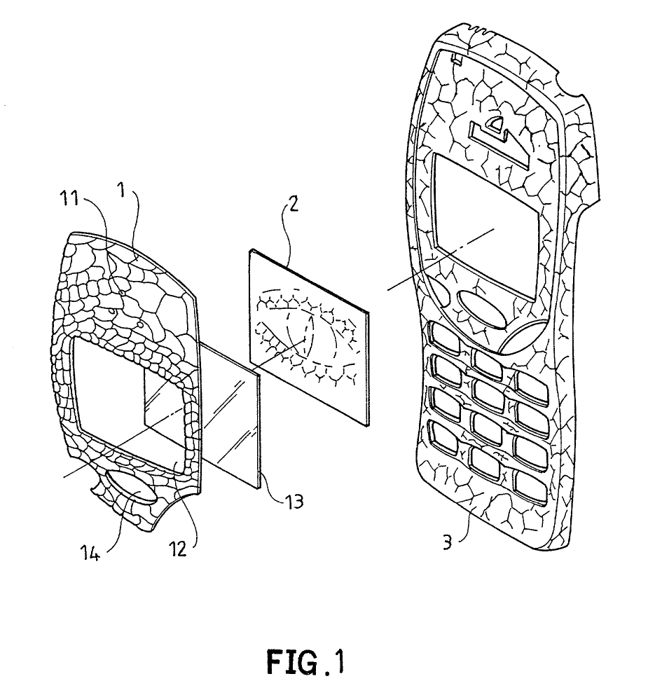

Referring to the drawings and initially to FIG. 1, a panel protective structure of a mobile telephone (or cellular phone) in accordance with the preferred embodiment of the present invention comprises a protective plate 1 fixed on the panel 3 of the mobile telephone and made of elastic material. The protective plate 1 includes a plurality of hearing holes 11, a viewing window 12, and a plurality of push button holes 14 respectively mating with the receiver, the display and the push buttons of the mobile telephone, which are not shown in the figure. The number, specification and arrangement of the elements of the protective plate 1 may be changed according to different kinds of mobile telephones. The protective plate 1 is a main body made of elastic material, and has a vibration absorbing function. The front side of the protective plate 1 is printed with spatial or planar patterns that may be varied and selected to have the configuration of the animal, plant or scene according different subjects, so as to decorate the appearance of the mobile telephone. The back face of the protective plate 1 is preferably fixed to the panel 3 of the mobile telephone by an adhesive method, so that the outer periphery of the main body is matingly combined on the panel 3 of the mobile telephone. The main body of the protective plate 1 is provided with a plurality of hearing holes 11, a viewing window 12, a mirror 13, and a plurality of push button holes 14, wherein the mirror 13 is fixed on the viewing window 12 to together mate with the display of the mobile telephone. A film plate 2 is fixed on the inner side of the mirror 13 by an adhesive. The film plate 2 is transparent, and is preferably provided with a pattern with a refractive effect, so that the refractive pattern can present different patterns at different angles.

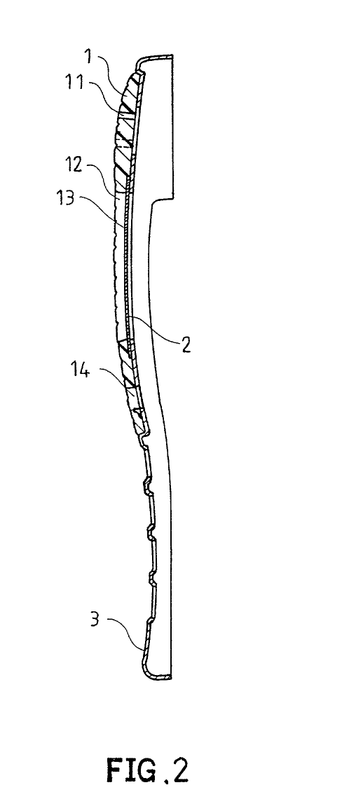

Referring to FIG. 2, the panel protective structure of the mobile telephone is combined with the panel of the mobile telephone. The body of the protective plate 1 presents a plane matingly combined with the curve of the panel of the mobile telephone. The body, the mirror 13, and the film plate 2 are serially and tightly adhered on the panel 3 of the mobile telephone to form an integrity. In the panel protective structure of the mobile telephone of the present invention, the body of the protective plate 1 encompasses the front side and the liquid crystal display of the mobile telephone that are most easily to be broken due to falling down, thereby efficiently protecting the front side and the liquid crystal display of the mobile telephone.

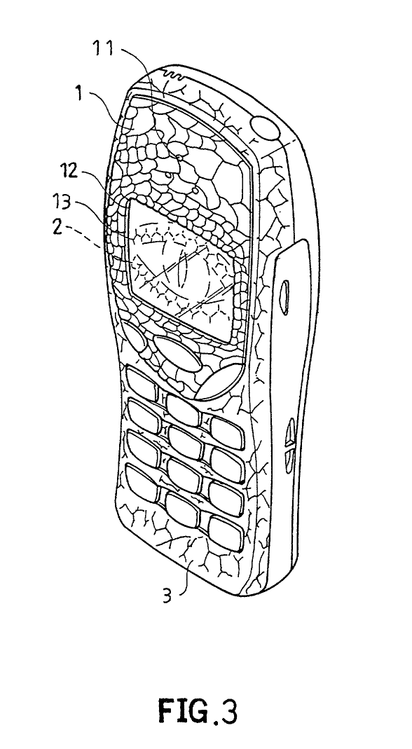

Referring to FIG. 3, the protective plate 1 is made of elastic material, and is provided with a spatial pattern, thereby increasing the shock absorbing effect, so that when the mobile telephone falls unintentionally, the protective plate 1 can reduce the impact force exerted on the mobile telephone 4, and can especially reduce the impact force directly exerted on the mirror 12 and the liquid crystal display of the mobile telephone 4, thereby efficiently preventing the mobile telephone from being worn, and thereby preventing the liquid crystal display from being broken.

Referring to FIGS. 1-3, for enhancing the appearance of the mobile telephone, the protective plate 1 and the film plate 2 are provided with patterns according to the subject design. The protective plate 1 of the present invention is provided with an eye frame of a dinosaur, and the film plate 2 is relatively provided with an eye of the dinosaur, while the panel of the mobile telephone is relatively provided with the pattern of the scale of the dinosaur, thereby enhancing the viewing effect of the mobile telephone, and thereby increasing the quality of the product. In addition, the film plate 2 has a pattern with a refractive effect, so that the refractive pattern can present different patterns at different angles.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A panel protective structure of a mobile telephone, comprising a protective plate fixed on a panel of a mobile telephone, and including:
a main body, made of elastic material, and having a vibration absorbing function, said main body fixed on an outer surface of said mobile telephone; and
a viewing window, mounted on said main body, and having a shape mating with a liquid crystal display of said mobile telephone;
said body of said protective structure encompassing a front side and a liquid crystal display of said mobile telephone that are most easily to be broken due to falling down, thereby efficiently protecting said front side and said liquid crystal display of said mobile telephone, said main body capable of reducing an impact force exerted on said mobile telephone, and capable of reducing an impact force directly exerted on said liquid crystal display of said mobile telephone, thereby efficiently preventing said mobile telephone from being worn, and thereby preventing said liquid crystal display from being broken.

2. The panel protective structure of a mobile telephone as claimed in claim 1, further comprising a mirror made of transparent material mounted on an inner side of said viewing window.

3. The panel protective structure of a mobile telephone as claimed in claim 1, wherein said main body includes a plurality of hearing holes, and a plurality of push button holes respectively mating with a receiver, and push buttons of said mobile telephone, and the number, the specification and the arrangement thereof may be changed according to different kinds of mobile telephones.

4. The panel protective structure of a mobile telephone as claimed in claim 1, wherein a front side of said main body is provided with spatial or planar patterns that may be varied and selected to have a configuration of an animal, a plant or a scene according different subjects, so as to decorate an appearance of the mobile telephone.

5. The panel protective structure of a mobile telephone as claimed in claim 4, further comprising a film plate provided with patterns according to a subject design.

6. The panel protective structure of a mobile telephone as claimed in claim 5, wherein said panel of said mobile telephone is provided with patterns mating with patterns of said main body and said film plate according to said subject design.

7. The panel protective structure of a mobile telephone as claimed in claim 6, wherein said main body is provided with an eye frame of a dinosaur, and said film plate is relatively provided with an eye of said dinosaur, while said panel of said mobile telephone is relatively provided with a pattern of a scale of said dinosaur, thereby enhancing a viewing effect of said mobile telephone.

8. The panel protective structure of a mobile telephone as claimed in claim 5, wherein said film plate has a pattern with a refractive effect, so that said refractive pattern can present different patterns at different angles.
